(19) United States
(12) Patent Application Publication
(10) Pub. No.: US 2009/0262299 A1
(43) Pub. Date: Oct. 22, 2009

(54) Corrective eyeglasses

(76) Inventor: Michael Viktor, Ajax (CA)

Correspondence Address: BIRCH STEWART KOLASCH & BIRCH, PO BOX 747, FALLS CHURCH, VA, 22040-0747, US

(21) Appl. No.: 11/988,948

(22) PCT Filed: Aug. 15, 2006
(86) PCT No.: PCT/CA2006/001331

§ 371 Date: Jan. 17, 2008

(30) Foreign Application Priority Data
Aug. 18, 2005 (CA) 2516672

(51) Int. Cl. G02C 7/16

(52) U.S. Cl. 351/45

(57) ABSTRACT

The lens of the subject corrective eyeglasses obstructs the vision of a preselected area but not the whole of the wearer's stronger eye, either by impairing his vision or entirely blocking it. When the vision is so obstructed, the wearer's weaker eye is forced to compensate for the stronger eye's loss by taking over the area of sight not visible by the stronger eye. The lens may be obstructed by applying over the preselected area of the lens a coating which distorts or blurs the object seen by the eye. Alternatively an opaque coating may be applied to the preselected area to entirely block the object. In either case, the wearer is forced to use his weaker eye to see the object impaired or blocked by the coating.

### FIELD OF THE INVENTION

This invention relates to corrective eyeglasses for persons having binocular impairment and more particularly to corrective eyeglasses in which at least one of its lenses has means for impairing or entirely blocking a portion of a wearer's field of vision.

### BACKGROUND OF THE INVENTION

Certain visual impairments such as those caused by amblyopia result in one eye being much stronger than the other. In such cases, the stronger eye generally overpowers the weaker eye and causes the weaker eye to function at less than its full potential. Over time, the binocular vision of a person who suffers from such an impairment can weaken to the point that, to all intents and purpose, the person is blind in one eye and has sight in only one eye. In other words the person has monocular vision.

The purpose of the corrective eyeglasses of the subject invention is to restore or improve the vision of a person who suffers from binocular impairment. A secondary purpose of the subject eyeglasses is to encourage the weaker eye of such person to exercise while allowing his or her stronger eye to continue to function. This is to be contrasted with the time-honoured method of covering the stronger eye entirely so that the person is deprived entirely of the use of his or her stronger eye and must function with only the limited sight from the weaker eye.

A third purpose of the eyeglasses of the subject invention is to exercise the muscles which control the eyes of persons who suffer from tunnel vision or other impairment of the eye. Such persons, while not visually impaired, can experience a vision that is defective in not adequately including objects away from the centre of their field of view.

### SUMMARY OF THE INVENTION

The lens of the subject corrective eyeglasses obstructs the vision of the wearer's stronger eye, either by impairing his vision or entirely blocking it. When the vision is so obstructed, the wearer's weaker eye is forced to compensate for the stronger eye's loss by taking over the area of sight not visible by the stronger eye. There are various means for obstructing the vision. One means involves the application of a coating to the lens. To this end, a coating may be applied to a portion of the lens in front of the stronger eye in order to distort or blur the object seen by the eye. Alternatively an opaque coating may be applied to a portion of the lens to entirely block the object. In both cases, the wearer is forced to use his weaker eye to see the object impaired or blocked by the coating.

Another means for obstructing the wearer's vision is to form a curvature in the front and back faces of the lens in the same way as curvatures are formed in the faces of prescription lenses. Unlike prescription lenses where the curvature is intended to correct a problem in the wearer's vision, the curvature of my corrective lens is intended to obstruction the wearer's vision by impairing it or entirely blocking it.

### DESCRIPTION OF THE DRAWINGS

The corrective eyeglasses of the subject invention are described with reference to the accompanying drawings each of which shows schematically the lens in front of a wearer's stronger or dominant eye and the lens in front of his weaker eye.

### DESCRIPTION OF PREFERRED EMBODIMENTS

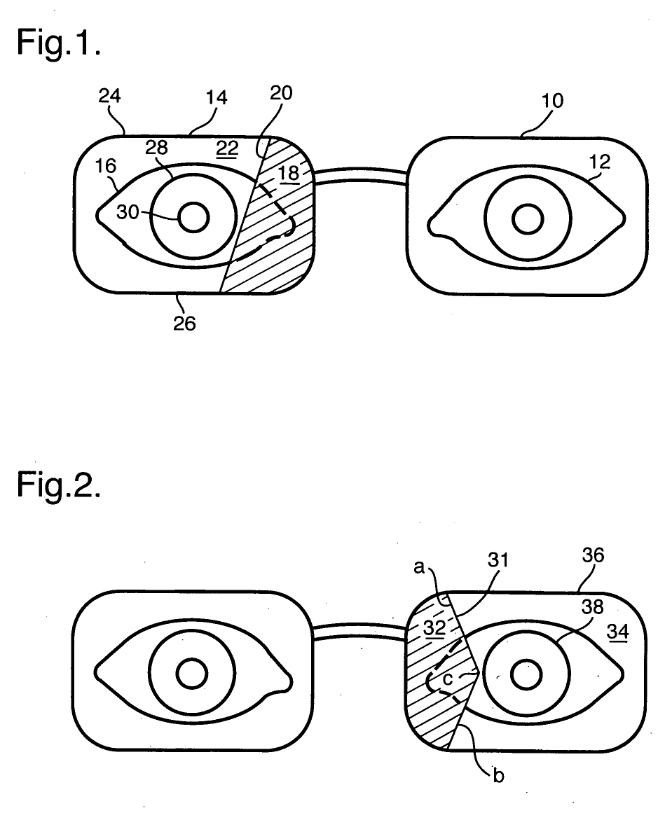

In FIG. 1, the eyeglasses have two lenses, a first 14 in front of the wearer's stronger eye 16 and a second 10 in front of the wearer's weaker eye 12. Lens 10 is unobstructed while lens 14 has an obstructed area 18 which blocks or distorts the wearer's vision. An oblique line 20 separates the obstructed area of the lens from the remaining unobstructed area 22. The line extends from the top 24 of the lens to the bottom 26 and is oriented such that the obstructed area is wider at the bottom than it is at the top.

The obstructed area is the to left of the pupil 30 of the wearer's stronger eye when he looks straight ahead but when looks to the left, part of his vision is obstructed. The width of the obstruction, measured horizontally, is smaller above the pupil than below it so that the wearer's vision is more obstructed when he looks down than when he looks up.

Since no part of the pupil is behind the obstructed area when the wearer is looking straight ahead, his forward vision is not impaired by the obstruction. Similarly when the wearer looks to the right his vision is not impaired since no part of his pupil is behind the obstruction. However when the wearer looks to the left, part of his pupil is behind the obstruction and his vision is impaired but more when he looks down than when he looks up.

The term “unobstructed area” in the context of this description is intended to mean an area of transparent material such as glass or plastic which concentrates or disperses light rays. The term may accordingly refer to a prescription lens which is normally worn in the eyeglasses of the wearer. The term is also intended to cover a material which does not optically alter the light rays such as clear, undistorted glass which is used to make window panes, drinking glasses and the like.

The term “obstructed area” may refer to a clear, undistorted glass which is overlaid with a coating which impairs or entirely blocks vision of the wearer of the eyeglasses. Alternatively, the term may refer to a lens which is overlaid with the same coating. Accordingly, the wearer's normal prescription lenses may become the eyeglasses of the invention where the lens through which the wearer's stronger eye sees is overlain with a coating which will impair or block the vision through that lens and where the other lens is unaltered by a coating.

In summary, line 20 extends downwardly through the wearer's field of vision and that the line is oriented such that the obstructed area 18 is wider, measured horizontally, at the bottom of the lens than it is at the top. When the wearer looks straight ahead and when he looks to the right side, he looks through the unobstructed area 22 but when the wearer looks to the left he looks at the obstructed area with resulting impairment of his field of vision. The extent of impairment is least when the wearer looks upwardly to the left and greatest when the wearer looks downwardly to the left.

It is believed that the obstructed area of the shape illustrated in FIG. 1 is most advantageous for allowing maximum field of vision while promoting binocular vision.

In FIG. 2, the eyeglasses consist of a first lens 36 in front of the stronger eye. A line 31 between the obstructed area 32 and the remainder 34 of the lens 36 consists of two segments a, b which converge toward a common point c on the same level as the wearer's pupil 38 but to the right of it so that the wearer's pupil is not covered by the obstructed area. By virtue of the shape of the line, the obstruction decreases in width above and below the eye.

The obstructed area is the to right of the pupil 38 of the wearer's stronger eye when he looks straight ahead and, as such, does not obstruct the wearer's forward vision. However when the wearer looks to the right, part of his vision is obstructed. The width of the obstruction is largest horizontally to the right of the eye but diminishes in width above and below the eye. Thus the wearer's vision is more obstructed when he looks horizontally to the right than it will be when he looks up and down to the right. When he looks to the left his vision will not be impaired by the obstruction.

In summary, line 31 extends downwardly through the field of vision and is oriented such that the horizontal width of the obstructed area 32 is generally the same at the bottom and the top of the lens. When the wearer looks straight ahead and when he looks to the left he looks through the unobstructed area but when the wearer looks to the right he looks at the obstructed area with resulting impairment of his field of vision. The extent of impairment is least when the wearer looks upwardly and downwardly to the right and greatest when the wearer looks horizontally to the right.

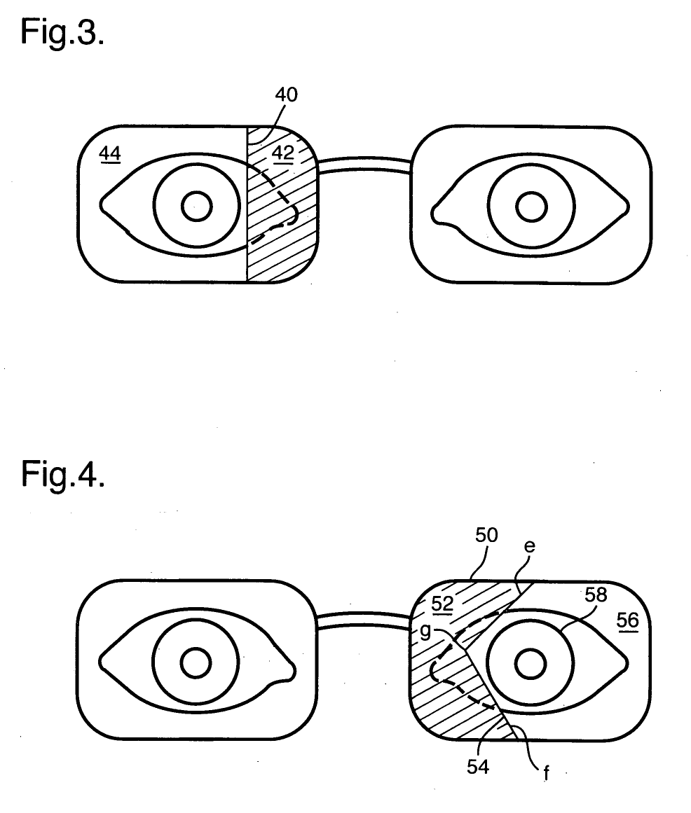

In FIG. 3 the line 40 which separates the obstructed area 42 from the remainder 44 of the first lens is vertical and again the pupil is not covered by the obstructed area. As a result when he looks straight ahead, his vision will not be obstructed. The obstructed area in the lens is the to left of the pupil of the wearer's stronger eye. When the wearer looks to the left his vision is obstructed by the same amount whether he looks up, down or horizontally to the left.

In summary, line 40 is vertical and extends downwardly through the field of vision. The line is oriented such that the horizontal width of the obstructed area 42 is the same from the bottom to the top of the lens. When the wearer looks straight ahead and when he looks to the right, he looks through the unobstructed area 44 of the lens but when the wearer looks to the left, he looks at the obstructed area 42 with resulting impairment of his field of vision. The extent of the impairment is the same whether the wearer looks upwardly to the left, downwardly to the left and horizontally to the left.

The first lens 50 of FIG. 4 is similar to that of lens 36 of FIG. 2 except that the obstructed area 52 is much larger than that of lens 36. In FIG. 4, the line 54 between the obstructed area 52 and the remainder 56 of the lens consists of two segments e, f which converge toward a common point g on the same level as the wearer's pupil.

The obstructed area 52 is to the right of the pupil of the wearer's stronger eye when he looks straight ahead and does not obstruct his vision. However when the wearer looks to the right, most of his vision is obstructed. The horizontal width of the obstruction is least horizontally to the right of the eye but increases in width above and below the eye. Thus the wearer's vision is less obstructed horizontally to the right than it is when he looks up and down to the right. When he looks to the left his vision is not impaired.

In summary, line 54 extends downwardly through the field of vision and is oriented such that the width, measured horizontally, of the obstructed area 52 is generally the same at the bottom and the top of the lens. When the wearer looks straight ahead and when he looks to left, he looks through the unobstructed area 56 but when the wearer looks to right he looks at the obstructed area with resulting impairment of his field of vision. The extent of impairment is greatest when the wearer looks upwardly and downwardly to the right and least when the wearer looks horizontally in the same direction.

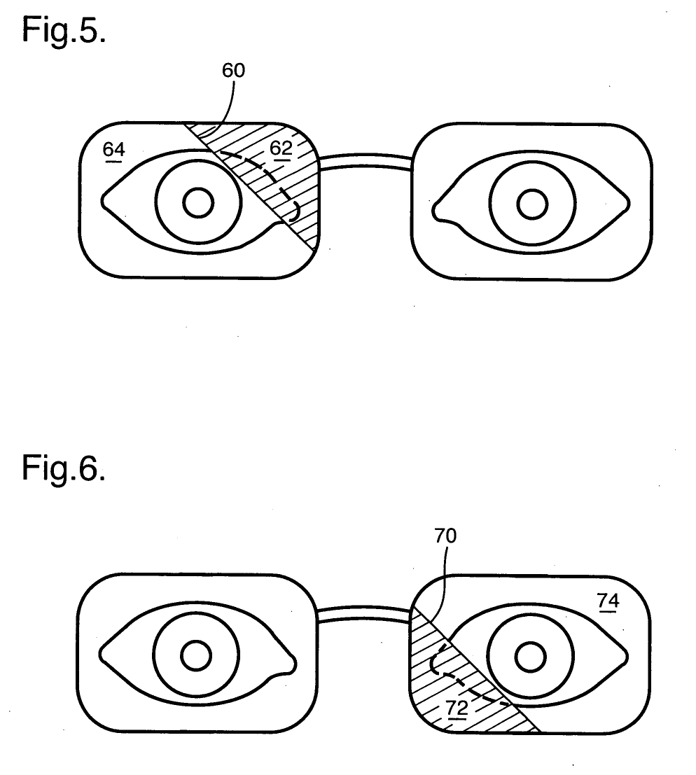

In FIG. 5 the line 60 between the obstructed area 62 and the remainder 64 of the lens is diagonal as is the line 70 between the obstructed area 72 and the remainder 74 of the lens in FIG. 6. In the former Figure, the obstructed area 62 is in the upper area of the lens while in the latter Figure, the obstructed area 72 is in the lower area.

In FIG. 5, the obstructed area is above and to the left of the of the wearer's stronger eye when he looks straight ahead and does not obstruct his forward vision. However when he looks vertically above or when he looks horizontally to the left or when he looks above and to the left, his vision is obstructed. His vision is less obstructed when he looks down and to the left than it is when he looks horizontally to the left, or when he looks upward and to the left or when he looks vertically straight up.

In FIG. 6, the obstructed area is below and to the right of the wearer's eye. The wearer's vision is less obstructed when he looks up and to the right than it is when he looks down and in the same direction.

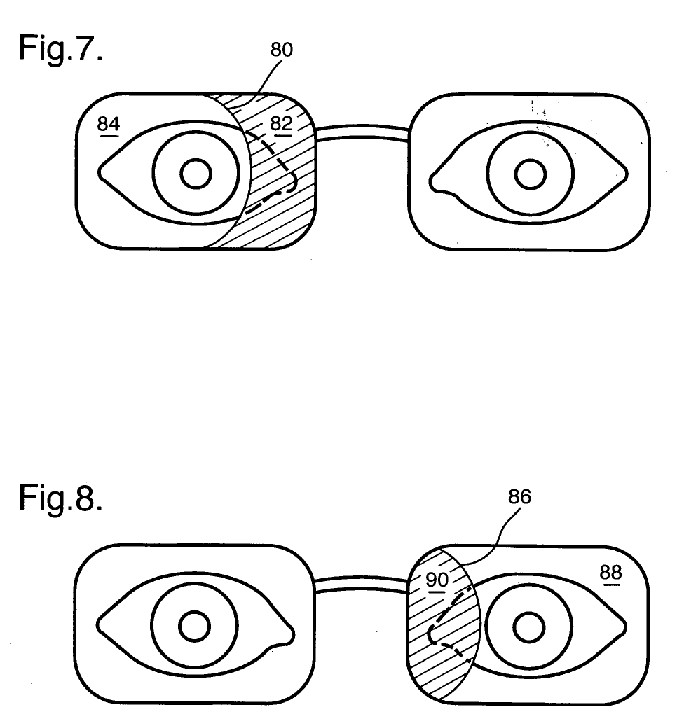

In FIG. 7 the line 80 which separates the obstructed area 82 from the remainder 84 of the lens is curved as is the line 86 which separates the obstructed area 90 from the remainder 88 of the lens illustrated in FIG. 8. In both lenses, the obstructed areas are elsewhere than in front of the wearer's pupil.

In the lens of FIG. 7, the wearer's vision through his stronger eye is obstructed if he looks to the left and is partially obstructed if he looks straight up or down. In the lens of FIG. 8, the wearer's vision through his stronger eye is obstructed if he looks to the right, whether horizontally or up or down, but is not be impaired if he looks straight up or down or to the left.

In summary, in FIG. 7, line 80 extends downwardly through the field of vision and is oriented such that the width, measured horizontally, of the obstructed areas 82 at the bottom and top of the lens is equal. When the wearer looks straight ahead and when he looks to right, he looks through the unobstructed area 84 but when the wearer looks to the left, he looks at the obstructed area 82 with resulting impairment of his field of vision. The extent of impairment is greatest when the wearer looks downwardly and upwardly to the left and least when the wearer looks horizontally to the same side.

In FIG. 8 line 86, like line 80 of FIG. 7, extends downwardly through the field of vision and is oriented such that the obstructed areas at the bottom and top of said lens are equal and such that when the wearer looks straight ahead and when he looks to the left he looks through the unobstructed area 88 but when he looks to the right he looks at the obstructed area 90 with resulting impairment of his field of vision. The extent of impairment is least when he looks downwardly and upwardly to the right and greatest when he looks horizontally in the same direction.

The lenses in the Figures show both straight and curved lines oriented at various angles that separate the obstructed areas from the remainder of the lenses. The Figures are illustrative of the various shapes and orientations of the line and are not intended to limit the lines to any particular shape or orientation.

The lenses of the subject invention may have a single focus, a double focus i.e. a bifocal or a triple focus i.e. a trifocal.

It will be understood, of course, that modifications can be made in the eyeglasses of the subject invention without departing from the scope and purview of the invention as defined in the appended claims.

I claim:

1. Corrective eyeglasses for use by a wearer having a binocular impairment, said eyeglasses having first and second lenses each adapted to be disposed in front of separate first and second eyes, respectively, of the wearer and each having a bottom, a top, an inside edge adjacent to the wearer's nose and an oppositely facing outside edge, said first lens having an obstructed area defined, in part by said inside edge for obstructing a portion of the field of vision of said first eye, the obstructed area being located such that the pupil of said first eye is wholly unobstructed by said area

2. The eyeglasses of claim 1 wherein said obstructing area is opaque and wholly prevents the wearer from seeing through said area.

3. The corrective eyeglasses of claim 1 wherein said first lens has an unobstructed area, said obstructed and unobstructed areas being separated by a line which extends downwardly through the field of vision, said line being oriented such that the width, measured horizontally, of the obstructed area is greater at the bottom of said first lens than it is at the top and such that when the wearer looks straight ahead and when he looks to one side, he looks through said unobstructed area but when the wearer looks to the other side he looks at said obstructed area with resulting impairment of his field of vision, the extent of which impairment being least when the wearer looks upwardly to the other said side and greatest when the wearer looks downwardly to the other said side.

4. The corrective eyeglasses of claim 1 wherein said first lens has an unobstructed area, said obstructed and unobstructed areas being separated by a line composed of a pair of segments which intersect one another and which extend downwardly through the field of vision, said line being oriented such that the width, measured horizontally, of the obstructed area is generally the same at the bottom and the top of said first lens and such that when the wearer looks straight ahead and when he looks to one side, he looks through said unobstructed area but when the wearer looks to the other side he looks at said obstructed area with resulting impairment of his field of vision, the extent of which impairment being least when the wearer looks upwardly and downwardly to the other said side and greatest when the wearer looks horizontally to the other said side.

5. The corrective eyeglasses of claim 1 wherein said first lens has an unobstructed area, said obstructed and unobstructed areas being separated by a vertical line which extends downwardly through the field of vision, said line being oriented such that the width, measured horizontally, of the obstructed area is the same from the bottom to the top of said first lens and such that when the wearer looks straight ahead and when he looks to one side, he looks through said unobstructed area but when the wearer looks to the other side he looks at said obstructed area with resulting impairment of his field of vision, the extent of which impairment being generally the same whether the wearer looks upwardly to the other said side, downwardly to the other said side and horizontally to the other said side.

6. The corrective eyeglasses of claim 1 wherein said first lens has an unobstructed area, said obstructed and unobstructed areas being separated by a line composed of a pair of segments which intersect one another and which extends downwardly through the field of vision, said line being oriented such that the width, measured horizontally, of the obstructed area is generally the same at the bottom and the top of said first lens and such that when the wearer looks straight ahead and when he looks to one side, he looks through said unobstructed area but when the wearer looks to the other side he looks at said obstructed area with resulting impairment of his field of vision, the extent of which impairment being greatest when the wearer looks upwardly and downwardly to the other said side and least when the wearer looks horizontally to the other said side.

7. The corrective eyeglasses of claim 1 wherein said first lens has an unobstructed area, said obstructed and unobstructed areas being separated by an oblique line which extends downwardly through the field of vision, said line being oriented such that the width, measured horizontally, of the obstructed area is wider at the top of said lens than it is at the bottom and such that when the wearer looks straight ahead and when he looks to one side, he looks through said unobstructed area but when the wearer looks to the other side he looks at said obstructed area with resulting impairment of his field of vision, the extent of which impairment being least when the wearer looks downwardly to the other said side and greatest when the wearer looks upwardly to the other said side.

8. The corrective eyeglasses of claim 1 wherein said first lens has an unobstructed area, said obstructed and unobstructed areas being separated by an oblique line which extends downwardly through the field of vision, said line being oriented such that the width, measured horizontally, of the obstructed area is wider at the bottom of said lens than it is at the top and such that when the wearer looks straight ahead and when he looks to one side, he looks through said unobstructed area but when the wearer looks to the other side he looks at said obstructed area with resulting impairment of his field of vision, the extent of which impairment being greatest when the wearer looks downwardly to the other said side and least when the wearer looks upwardly to the other said side.

9. The corrective eyeglasses of claim 1 wherein said first lens has an unobstructed area, said obstructed and unobstructed areas being separated by a curved line which extends downwardly through the field of vision, said line being oriented such that the width, measured horizontally, of the obstructed areas at the bottom and top of said first lens are equal and such that when the wearer looks straight ahead and when he looks to one side, he looks through said unobstructed area but when the wearer looks to the other side he looks at said obstructed area with resulting impairment of his field of vision, the extent of which impairment being greatest when the wearer looks downwardly and upwardly to the other said side and least when the wearer looks horizontally to the other said side.

10. The corrective eyeglasses of claim 1 wherein said first lens has an unobstructed area, said obstructed and unobstructed areas being separated by a curved line which extends downwardly through the field of vision, said line being oriented such that the width, measured horizontally, of the obstructed areas at the bottom and top of said first lens are equal and such that when the wearer looks straight ahead and when he looks to one side, he looks through said unobstructed area but when the wearer looks to the other side he looks at said obstructed area with resulting impairment of his field of vision, the extent of which impairment being least when the wearer looks downwardly and upwardly to the other said side and greatest when the wearer looks horizontally to the other said side.

11. Corrective eyeglasses for use by a wearer having a binocular impairment, said eyeglasses having first and second lenses each adapted to be disposed in front of separate first and second eyes, respectively, of the wearer and each having a bottom, a top, an inside edge adjacent to the wearer's nose and an oppositely facing outside edge, said first lens having an obstructed area which is opaque and wholly prevents the wearer from seeing through said area, said area being defined, in part by said inside edge for obstructing a portion of the field of vision of said first eye, the obstructed area being located such that the pupil of said first eye is wholly unobstructed by said area.

12. The corrective eyeglasses of claim 11 wherein said first lens has an unobstructed area, said obstructed and unobstructed areas being separated by an oblique line which extends downwardly through the field of vision, said line being oriented such that the width, measured horizontally, of the obstructed area is wider at the bottom of said lens than it is at the top and such that when the wearer looks straight ahead and when he looks to one side, he looks through said unobstructed area but when the wearer looks to the other side he looks at said obstructed area with resulting impairment of his field of vision, the extent of which impairment being greatest when the wearer looks downwardly to the other said side and least when the wearer looks upwardly to the other said side.
